(19) United States
(12) Patent Application Publication
(10) Pub. No.: US 2025/0080683 A1
(43) Pub. Date: Mar. 6, 2025

(54) AUTOMATIC BACKGROUND REMOVAL OF IMAGES

(71) Applicant: Xerox Corporation, Norwalk, CT (US)

(72) Inventors: Xing LI, Webster, NY (US); Guo-Yau LIN, Fairport, NY (US); Vignesh DOSS, Palani Chettipatti (IN); Yongyi YE, Penfield, NY (US)

(73) Assignee: Xerox Corporation, Norwalk, CT (US)

(21) Appl. No.: 18/240,533

(22) Filed: Aug. 31, 2023

(51) Int. Cl. H04N 1/60; G06T 3/40; G06T 5/40; G06T 7/90; G06V 10/56

(52) U.S. Cl. CPC H04N 1/6008; G06T 3/4007; G06T 5/40; G06T 7/90; G06V 10/56; G06T 2207/10024

(57) ABSTRACT

A computationally efficient way is provided to enable background adjustment based on real time, automatic background detection. In one form, the real time detected paper white is used to dynamically adjust 1D LUTs that map the input pixel values before accessing a 3D LUT that stores the weights between the original input pixel value and white (e.g., 255, 128, 128 in L*a*b*). The more complex calculation of generating coefficients in the 3D LUT is made independent of the paper white point. In one form, the white point is calculated based on the histogram of the image collected from the lead edge or the full page.

### BACKGROUND

Background removal is an important function in multifunction devices. There have been various approaches aimed at improving various aspects of background detection and removal.

For example, in home and/or office environments, it can be a challenge to handle white paper stock/media typically used in those environments. That is, variations in devices, e.g., scanners, cause inconsistency in processing and/or rendering backgrounds, e.g., white backgrounds. In this regard, digital image capture devices, such as scanners and cameras, capture images as an array of pixels, with each pixel being assigned a set of color values in a multi-dimensional color space, such as RGB (red, green, blue) color space, referred to herein as an input color space. Processing images captured by digital devices is generally performed in a multi-dimensional color space with a larger gamut, such as the L*a*b* color space, referred to herein as a processing or device independent color space. The processed image may then be converted to a multi-dimensional output color space, suitable for rendering the processed image, such as CMYK (Cyan, Magenta, Yellow, and Black), in the case of printing.

During image processing, various adjustments to the image may be made. These adjustments are often performed sequentially, and may include image resolution adjustments, color corrections, removal of undesirable artifacts, cropping, and background suppression.

Background suppression is a useful function provided by the image path in copiers and multi-functional systems that removes or unifies the color of the background in the digitally acquired image. Background suppression removes the background or makes the background uniform to make the electronic image appear more uniform and consistent. Background suppression is more difficult for input images that contain poor contrast between foreground and background regions. Unwanted background may exist for many reasons, such as an aged, discolored, and/or dirty document(s) which are scanned to produce the input images. Additionally, the original may be printed on a color substrate or recycled paper which the customer generally does not want to reproduce. Thin paper stock may also be problematic, as this tends to increase the probability of show-through created by detecting and rendering content from the opposite side of a 2-sided print. Users generally do not want to have extraneous dots or background reproduced in their copies but rather desire to have a faithful rendition of the actual content contained within the original print. Background suppression helps to improve the contrast between the foreground and background regions.

In order to achieve an acceptable throughput, the complexity of background suppression algorithms has generally been limited by the processing capabilities of image processing devices, such as printer processors. Algorithms have been developed which segment images into foreground and background regions and then apply a correction only to the background regions. A threshold is set with the aim of producing uniform background region(s), typically white (no color), without undesirably impacting the foreground region(s). The threshold may be close to, but less than, the maximum value. On the luminance channel, for example, with a scale of 0-255, where 0 is black and 255 is white, a threshold value 250 could be set and all pixel values at or above the threshold are increased, by applying a gain, to bring them to 255, i.e., white. However, pixels below 250 are not adjusted, remaining gray. The chrominance channels may be similarly adjusted. As a result, in many existing threshold-based segmentation classification algorithms, abrupt switching artifacts may be generated, which are visible in the output image as uneven foreground or background regions. These are often referred to as “punch-through” artifacts in halftone and highlight regions.

These and other current techniques for background detection and adjustment address these challenges in various ways. However, there is still a need for improved techniques to meet these challenges.

### BRIEF DESCRIPTION

In accordance with one aspect of the presently described embodiments, an image processing system comprises at least one processor and at least one memory wherein the memory has instructions stored thereon that, when executed by the processor, cause the system to receive input RGB image data, convert the input RGB image data to L*a*b* image data, process background of the L*a*b* image data, determine a white point of the background, map entries based on the white point to one-dimensional look-up tables, and, perform trilinear interpolation based on the mapped data.

In another aspect of the presently described embodiments, the system is further caused to conduct post-process weighting.

In another aspect of the presently described embodiments, the system is further caused to adjust background.

In another aspect of the presently described embodiments, processing background comprises collecting a histogram of the L*a*b* image data.

In another aspect of the presently described embodiments, processing background comprises analyzing the histogram of the L*a*b* image data to determine a background color value.

In another aspect of the presently described embodiments, processing background comprises processing or adjusting pixels based on proximity of a pixel value to the determined background color value.

In accordance with another aspect of the presently described embodiments, an image processing method comprises receiving input RGB image data, converting the input RGB image data to L*a*b* image data, processing background of the L*a*b* image data, determining a white point of the background, mapping entries based on the white point to one-dimensional look-up tables, and performing trilinear interpolation based on the mapped data.

In another aspect of the presently described embodiments, the method further comprises conducting post-processing weighting.

In another aspect of the presently described embodiments, the method further comprises adjusting background.

In another aspect of the presently described embodiments, processing background comprises collecting a histogram of the L*a*b* image data.

In another aspect of the presently described embodiments, processing background comprises analyzing the histogram of the L*a*b* image data to determine a background color value.

In another aspect of the presently described embodiments, processing background comprises processing or adjusting pixels based on proximity of a pixel value to the determined background color value.

In accordance with another aspect of the presently described embodiments, a non-transitory computer readable medium having stored thereon instructions that, when executed, causes a system to receive input RGB image data, convert the input RGB image data to L*a*b* image data, process background of the L*a*b* image data, determine a white point of the background, map entries based on the white point to one-dimensional look-up tables, and perform trilinear interpolation based on the mapped data.

In accordance with another aspect of the presently described embodiments, the executed instructions further cause the system to conduct post-processing weighting.

In accordance with another aspect of the presently described embodiments, the executed instructions further cause the system to adjust background.

In another aspect of the presently described embodiments, processing background collecting a histogram of the L*a*b* image data.

In another aspect of the presently described embodiments, processing background analyzing the histogram of the L*a*b* image data to determine a background color value.

In another aspect of the presently described embodiments, processing background processing or adjusting pixels based on proximity of a pixel value to the determined background color value.

In accordance with another aspect of the presently described embodiments, an image processing system comprises at least one processor, and at least one memory wherein the memory has instructions stored thereon that, when executed by the processor, cause the system to receive input image data having values in an input color space, convert the input image data to device independent image data having values in a device independent color space, process background of the device independent image data, determine a white point of the background, map entries based on the white point to one-dimensional look-up tables, and, perform trilinear interpolation based on the mapped data.

### BRIEF DESCRIPTION OF THE DRAWINGS

FIG. 1 is a flow diagram illustrating aspects of the presently described embodiments;

FIG. 2A shows an example result from implementation of the presently described embodiments;

FIG. 2B shows an example result from implementation of the presently described embodiments; and,

FIG. 3 is a block diagram illustrating a representative system into which the presently described embodiments may be implemented.

### DETAILED DESCRIPTION

The presently described embodiments provide improved image quality over prior methods. For example, as compared to prior methods, the presently described embodiments are more effective in removing background and, at the same time, better at preserving highlight contents.

In this regard, in at least one form, the presently described embodiments relate to a method and system for detecting and removing background in a scanned image. The presently described embodiments may be implemented using a variety of software and/or hardware configurations used in connection with, for example, image processing devices such as, for example, multi-function devices incorporating printing, scanning, and/or other processes.

This approach has the feature of calculating the white point or the background of the image by continuously analyzing in real-time the scanned image. Various alternatives may be used to detect or calculate the white point or background. One example implementation includes analyzing the histogram of the lead edge or full-page of the image.

One-dimensional (1D) Look Up Tables (LUTs) that map the input pixel values are dynamically adjusted before accessing a three-dimensional (3D) Look Up Table (LUT) that stores the weights between the original input pixel value and white (e.g., 255, 128, 128 in L*a*b*). The output of these calculations results in a smoother transition to the replaced pixels. For example, if the detected white point values are 225, 131, 126 in L*a*b* and pixels with this value (and other pixels with L*>=225, a* close to 131 and b* close to 126 by a certain measure) are mapped to the (desired output) white of 255, 128, 128, the “smooth transition” here is for pixels close in value to the ones described above (that are mapped to white or 255, 128, 128) but not mapped all the way to white. With the presently described embodiments, a known but more complex calculation of generating coefficients in the 3D LUT is made independent of the paper white point.

That is, in at least one form, the presently described embodiments introduce a computationally efficient way to enable the background adjustment based on real time, automatic background detection. Specifically, the real time detected paper white is used to dynamically adjust the 1D LUTs that map the input pixel values before accessing the 3D LUT that stores the weights between the original input pixel value and white (e.g., 255, 128, 128 in L*a*b*). With the presently described embodiments, the typically more complex calculation of generating coefficients in the 3D LUT is made independent of the paper white point. In at least one form, as noted above, the white point is calculated based on the histogram of the image collected from the lead edge or the full page.

In contrast, in an example known system, i.e., a background adjustment technique of U.S. Pat. No. 10,986,250 to Metcalfe et al., which is commonly owned and incorporated herein by reference in its entirety, an output of background adjustment is a weighted average of the original pixel value and the output white point (e.g., 255, 128, 128 in L*a*b*). The closer the input pixel value is to the white background, which is pre-defined in existing systems, the more weight is applied on the output white point. However, when the input pixel value is reasonably distant from the pre-defined white background, no additional weight is applied and the original input pixel value is used as output. In other words, only a limited region is affected by the adjustment and the transition is made gradual. In one form, the weights corresponding to different input pixel values are stored in a 3D LUT of the size 15×15×15. The input pixel values are converted to weights via trilinear interpolation, with three 1 D LUTs, i.e., xmap, ymap and zmap, placed in front of the 3D interpolation to map input pixel values to intermediate values for identifying the interpolation lattice points. These 1 D LUTs also play the role of enabling the interpolation lattice points to be concentrated on the region of interest. In some implementations, the interpolated weight is further processed/adjusted via operations such as low-pass filtering. While all the LUTs in the system are programmable, the parameter design is subject to trial and error, and, in one example, useful for pre-selected paper stocks.

According to the presently described embodiments, in at least one form, a framework for handling such background adjustment based on real time detection results is realized. In this regard, in at least one form of the presently described embodiments, the real time detected paper white is used to dynamically adjust the 1D LUTs that are in front of the trilinear interpolation. Using trilinear interpolation involves complex calculation/programming of the 3D LUT, which captures the result of parameter optimization to achieve a preferred profile of transition from highlight content to background white. Using the presently described embodiments, this trilinear interpolation is made static, or independent of the real-time paper white detection result. In other words, the 1D LUTs specify where the transition from weight=0 (100% input pixel value, 0% output white) to weight=1 (0% input pixel value, 100% output white) happens and the coefficients in the 3D lattice points specify how the transition is carried out.

For example, Table 1a (below) shows the mapping from input pixel value to xmap output to the weights stored in the 3D LUT to the final output. For simplicity, only the luminance part, or data along the neutral axis, is shown and the post processing of weight out of the 3D LUT is not shown. In the example shown in Table 1a, the white point detected has an L* of 211, and a range of 211-159 or 52 is allocated for the transition of weight from 0 to 1. While the relationship between column 1 and column 2, or input pixel value, xmap output is dynamically determined based on detection result, the relationship between column 2 and column 3, or lattice point and weight, is static. In other words, in this exemplary implementation, if the white point detected is 220 instead of 211, then xmap[220] will be set to 13 as shown in Table 1 b.

TABLE 1a
Background adjustment example a

| Input pixel | Lattice point | | Output pixel |
|---|---|---|---|
| value | (xmap output) | Weight | value |
| 159 | 0 | 0 | 159 |
| 163 | 1 | 0 | 163 |
| 167 | 2 | 0.005 | 167 |
| 171 | 3 | 0.023 | 173 |
| 175 | 4 | 0.057 | 180 |
| 179 | 5 | 0.105 | 187 |
| 183 | 6 | 0.190 | 197 |
| 187 | 7 | 0.315 | 208 |
| 191 | 8 | 0.440 | 219 |
| 195 | 9 | 0.565 | 229 |
| 199 | 10 | 0.690 | 238 |
| 203 | 11 | 0.815 | 245 |
| 207 | 12 | 0.920 | 251 |
| 211 | 13 | 1 | 255 |
| 215 | 14 | 1 | 255 |

TABLE 1b
Background adjustment example b

| Input pixel | Lattice point | | Output pixel |
|---|---|---|---|
| value | (xmap output) | Weight | value |
| 168 | 0 | 0 | 168 |
| 172 | 1 | 0 | 172 |
| 176 | 2 | 0.005 | 176 |
| 180 | 3 | 0.023 | 182 |
| 184 | 4 | 0.057 | 188 |
| 188 | 5 | 0.105 | 195 |
| 192 | 6 | 0.190 | 204 |
| 196 | 7 | 0.315 | 215 |
| 200 | 8 | 0.440 | 224 |
| 204 | 9 | 0.565 | 233 |
| 208 | 10 | 0.690 | 240 |
| 212 | 11 | 0.815 | 247 |
| 216 | 12 | 0.920 | 252 |
| 220 | 13 | 1 | 255 |
| 224 | 14 | 1 | 255 |

In one example implementation, the 1D LUTs of xmap, ymap and zmap are 256-entry LUTs of floating-point values with the integer part used to identify the lattice point and the fractional part used to perform interpolation.

TABLE 2
An example of 1D LUT xmap

| Input pixel | xmap output |
|---|---|
| 0 | 0 |
| 1 | 0 |
| 2 | 0 |
| . . . | |
| 158 | 0 |
| 159 | 0 |
| 160 | 0.25 |
| 161 | 0.50 |
| 162 | 0.75 |
| 163 | 1 |
| 164 | 1.25 |
| 165 | 1.50 |
| 166 | 1.75 |
| 167 | 2 |
| 168 | 2.25 |
| . . . | |
| 211 | 13 |
| 212 | 13.25 |
| 213 | 13.50 |
| 214 | 13.75 |
| 215 | 14 |
| 216 | 14 |
| . . . | |
| 255 | 14 |

Table 2 shows some elements in the xmap LUT corresponding to a detected white point of 211, as in the example depicted in Table 1a. It will be appreciated that some data entries (e.g., 159, 163, 167, 211 and 215) are already listed in Table 1a. The others shown in Table 2 are interpolations. Note, that while the example shown in Table 2 the mapping from input pixel values to the xmap entries is linear (in the section where the transition from 0 to 1 occurs), it doesn't have to be constrained in that manner.

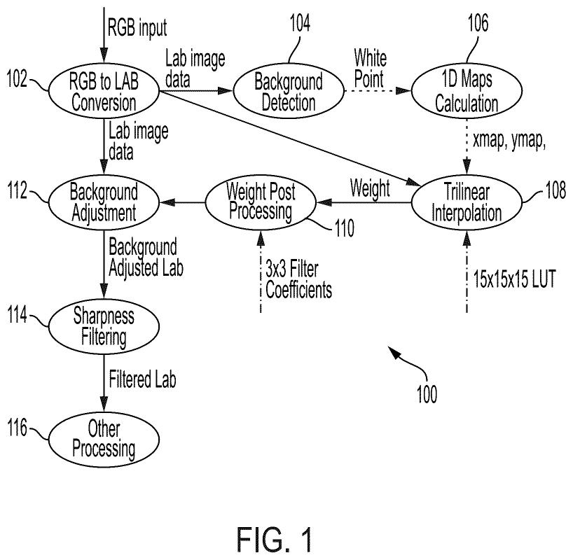

With reference now to FIG. 1, the flow diagram shown illustrates a software-based image path with automatic background removal. The new background detection or processing function, according to the presently described embodiments, is implemented as an advanced tiling kernel in which histogram collection is done in the kernel function that operates on a tile-by-tile basis and white point calculation from the histogram is done in the post-process function of the kernel. As illustrated in the examples described above using the example Tables 1a, 1b, and 2 in connection with at least one form of the presently described embodiments, the mapping from detected white point to the entries in the 1D LUTs in front of the trilinear interpolation is performed in the 1D Maps Calculation kernel. At graph execution time, the 1D Maps Calculation node dynamically program the 1D LUTs when it receives the white point from the Background Detection node.

More specifically, as shown, a method 100 is initiated with the receipt of RGB input data (or other input image data having values defined in an input color space) that is converted to L*a*b* data (or other image data having values defined in a device independent color space) (at 102). The L*a*b*, or other device independent, image data is then used to detect or process background (at 104). It should be appreciated that background may be detected or processed in a variety of manners. For example, as described above and in at least one implementation of the presently described embodiments, a histogram of the image is collected and analyzed to determine the background color (or background white) of the document (e.g., 225, 131, 126). As illustrated in the examples described above using the example Tables 1a, 1b, and 2 in connection with at least one form of the presently described embodiments, to further process the background, pixels are processed or adjusted based on how close (e.g., its proximity) its value is to the detected background value (weighted average between the original value and white (255, 128, 128)). A white point is determined for the background and used to create mapping entries based on the white point to 1D LUTs (at 106). A trilinear interpolation is then performed based on the mapped data (at 108).

Subsequently, post-processing weighting is conducted (at 110) and any necessary background adjustment is made (at 112). Sharpness filtering (at 114) and other processing (at 116) may then be completed. Of course, the image data processed according to the presently described embodiments may be output or used in any of a variety of manners and environments.

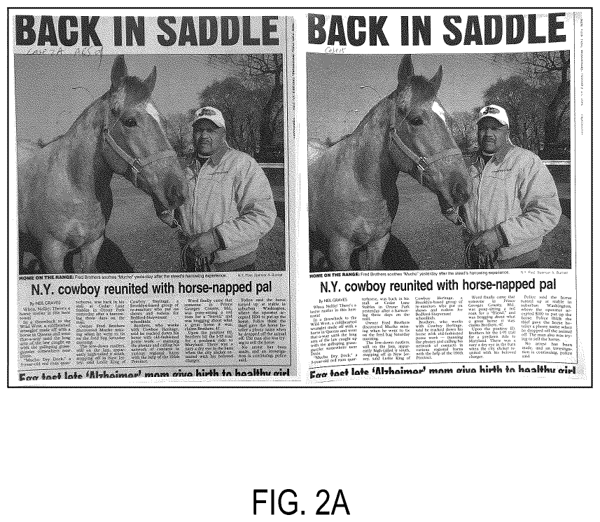

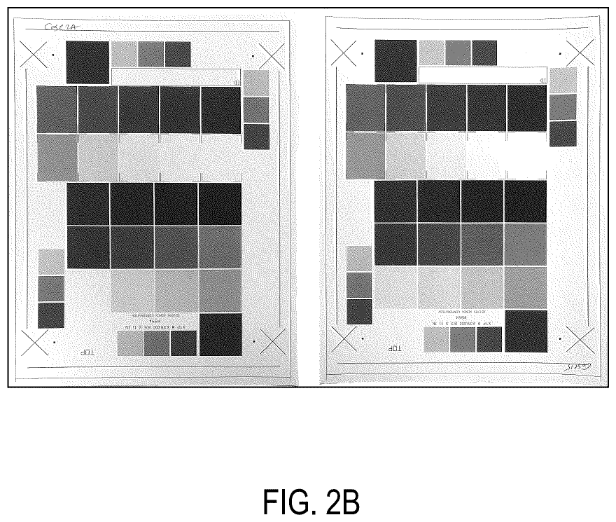

Implementation of the presently described embodiments, including for example, the method described in FIG. 1, results in improved images. For example, FIGS. 2A and 2B show sample results with the image on the left being output generated with a prior system and technique and the image on the right output with the presently described embodiments. As shown, the presently described embodiments provide improved image quality over that which is enabled with prior systems, such as the prior system used to generate the examples shown. The images shown are in gray scale for convenience. However, those of skill in the art will appreciate that color versions of these images would illustrate additional and/or more intense differences. As shown, FIG. 2A illustrates that the background (e.g., white newspaper as background for text and photographs) in the right-side image, generated using the presently described embodiments, is definitively more white than the same areas in the left-side image, generated using an example prior system. Likewise, in FIG. 2B, the right-side image, generated using the presently described embodiments, illustrates a much higher degree of highlight preservation than the left-side image, generating using the example prior system. Those of skill in the art will appreciate that the right-side image preserves the varying degrees of highlighting and/or shading present in the image much more effectively than the left-side image—wherein several blocks incorrectly appear to have the same or a too similar level of highlighting, shading, or color. Thus, the presently described embodiments are more effective in removing and adjusting background and at the same time, better at preserving highlight contents.

The technique described in connection with the presently described embodiments may be implemented in a variety of different suitable environments and/or architectures that will be apparent to those skilled in the art upon a reading and understanding of the presently described embodiments. For example, a system and method are described which provide image processing while minimizing artifacts occurring during background suppression. The background suppression may form a step in a software image path (SWIP), as described herein, or be performed as a stand-alone operation.

Further, as used herein, an “image processing device” can include any device for rendering an image such as a copier, laser printer, bookmaking machine, facsimile machine, scanner or a multi-function machine (which includes one or more functions such as scanning, printing, archiving, emailing, and faxing)-some of which may render an image on print media.

“Print media” can be a physical sheet of paper, plastic, or other suitable physical print media substrate for carrying images. For example, the print media can be substantially any type of media upon which a marking engine can print, such as: high quality bond paper, lower quality “copy” paper, overhead transparency sheets, high gloss paper, colored paper, and so forth. A “job” or “document” is referred to for one or multiple sheets copied from an original job sheet(s) or an electronic document page image, from a particular user, or otherwise related. According to systems and methods herein, a “job” can be a print job, a copy job, a scan job, etc.

An “original image” or “input image” is used herein to mean an electronic (e.g., digital) recording of information. The original image may include image data in the form of text, graphics, or bitmaps.

As used herein, a “pixel” refers to the smallest segment into which an image can be divided. Received pixels of an input image are associated with a color value defined in terms of a color space (e.g., an input color space), such as color, intensity, lightness, brightness, or some mathematical transformation thereof. Pixel color values may be converted to a device independent color space such as chrominance-luminance space, such as L*a*b*, using, for instance, an RGB-to-L*a*b* converter to obtain luminance (L*) and chrominance (a*b*) values. It should be appreciated that pixels may be represented by values other than RGB or L*a*b*.

The L*a*b* color space has an L dimension for lightness and a and b that are color-opponent dimensions (i.e., chrominance), and are based on nonlinearly compressed coordinates. The L*a*b* color space includes all perceivable colors, which means that its gamut exceeds those of the RGB and CMYK color spaces, but the L*a*b*-color space is device independent, which means that the colors are defined independent of their nature of creation or the device on which they are output (displayed or rendered).

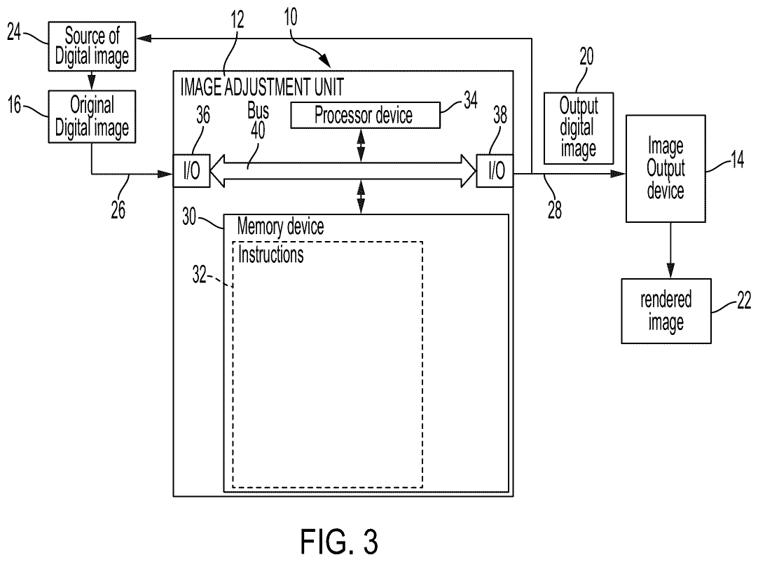

FIG. 3 illustrates an exemplary image processing device 10 according to at least one form of the presently described embodiments. The image processing device includes an image adjustment unit 12 and optionally an image output device 14. The image adjustment unit 12 receives an original digital image 16, such as a scanned image, in a first (input) color space, such as RGB. The image adjustment unit 12 converts the original image or input image data 16 to, for example, another format or type such as device independent image data having values defined in a second color space or a device independent color space such as, a luminance-chrominance color space, such as L*a*b*, in which, according to the presently described embodiments, image adjustments are made to form an adjusted digital image. The adjustments, for example, include background adjustment, as needed and/or as illustrated in the examples described above using the example Tables 1a, 1b, and 2 in connection with at least one form of the presently described embodiments. The image adjustment unit 12 may convert the adjusted digital image to an output digital image 20 in a third (output) color space, in which the output device 14 operates, such as CMYK. The exemplary output device 14 includes a marking device which renders the output digital image 20 on print media, using marking materials, such as inks or toners, to form a rendered (generally, hardcopy) image 22. The image processing device 10 may further include or be communicatively connected with a source 24 of original digital images, such as a scanner or computing device. In some embodiments, such as a scan-to-copy image processing path, the output image 20 may be stored in local or remote memory, such as in the source 24 of digital images. Components 12, 14, 24 of the image processing device 10 may be communicatively connected by wired or wireless links 26, 28, such as wires, a local area network, or a wide area network, such as the Internet.

The image adjustment unit 12 includes main memory 30 which stores software instructions 32 for performing the processing that generate the adjusted image and output image 20 according to at least one form of the presently described embodiments. A processor 34, in communication with the memory 30, executes the instructions. The image adjustment unit 12 also includes one or more input/output (I/O) devices 36, 38 for receiving original images 16 and outputting the output images 20. Hardware components 30, 34, 36, 38 of the image correction unit 12 may communicate via a data/control bus 40.

The image adjustment unit 12 may include one or more computing devices, such as a microprocessor, a PC, such as a desktop, laptop, or palmtop computer, portable digital assistant (PDA), server computer, cellular telephone, tablet computer, combination thereof, or other computing device capable of executing instructions for performing the exemplary method.

The memory 30 may represent any type of non-transitory computer readable medium such as random-access memory (RAM), read only memory (ROM), magnetic disk or tape, optical disk, flash memory, or holographic memory. In one embodiment, the memory 30 comprises a combination of random-access memory and read only memory. In some embodiments, the processor 34 and memory 30 may be combined in a single chip. Memory 30 stores instructions for performing the exemplary method as well as the processed data.

The input/output (I/O) devices 36, 38 allow the image adjustment unit 12 to communicate with other devices via a computer network, such as a local area network (LAN) or wide area network (WAN), or the internet, and may comprise a modulator/demodulator (MODEM) a router, a cable, and/or Ethernet port.

The digital processor device 34 can be variously embodied, such as by a single-core processor, a dual-core processor (or more generally by a multiple-core processor), a digital processor and cooperating math coprocessor, a digital controller, or the like. The digital processor 34, in addition to executing instructions 32 may also control the operation of the output device 14. In one embodiment, the processor may be or include a special purpose processor that is specialized for processing image data and may include application-specific integrated circuits (ASICs) that are specialized for the handling of image processing operations, processing image data, calculating pixel values, and the like. The processor may include a raster image processor (RIP), which uses the original image description to RIP the job. Accordingly, for a print job, the print instruction data is converted to a printer-readable language. The print job description is generally used to generate a ready-to-print file. The ready-to-print file may be a compressed file that can be repeatedly accessed for multiple (and subsequent) passes.

As illustrated above, those of skill in the art will appreciate that the presently described embodiments implemented as described may also include a software and/or instruction component in the various implementations. In this regard, the term “software instructions” or simply “instructions,” as used herein, is intended to encompass any collection or set of instructions executable by a computer or other digital system so as to configure or cause the computer or other system, including a digital system, to perform the task that is the intent of the software. The term “software” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

Further, it should be appreciated that the method illustrated in FIG. 1 may be implemented in a computer program product that may be executed on a computer such as a computer system described herein or otherwise. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the image adjustment unit 12 (for example, an internal hard drive of RAM), or may be separate (for example, an external hard drive operatively connected with the unit 12), or may be separate and accessed via a digital data network such as a local area network (LAN) or the Internet (for example, as a redundant array of inexpensive or independent disks (RAID) or other network server storage that is indirectly accessed by the unit 12, via a digital network).

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 1, can be used to implement the method for image adjustment. As will be appreciated, while the method may be computer implemented, in some embodiments one or more of the steps may be at least partially performed manually. As will also be appreciated, the steps of the method need not all proceed in the order illustrated and fewer, more, or different steps may be performed.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. An image processing system comprising:
at least one processor; and
at least one memory wherein the memory has instructions stored thereon that, when executed by the processor, cause the system to:
receive input RGB image data;
convert the input RGB image data to L*a*b* image data;
process background of the L*a*b* image data;
determine a white point of the background;
map entries based on the white point to one-dimensional look-up tables; and,
perform trilinear interpolation based on the mapped data.

2. The image processing system of claim 1, wherein the system is further caused to:
conduct post-process weighting.

3. The image processing system of claim 1, wherein the system is further caused to:
adjust background.

4. The image processing system of claim 1, wherein processing background comprises collecting a histogram of the L*a*b* image data.

5. The image processing system of claim 4, wherein processing background comprises analyzing the histogram of the L*a*b* image data to determine a background color value.

6. The image processing system of claim 5, wherein processing background comprises processing or adjusting pixels based on proximity of a pixel value to the determined background color value.

7. An image processing method comprising:
receiving input RGB image data;
converting the input RGB image data to L*a*b* image data;
processing background of the L*a*b* image data;
determining a white point of the background;
mapping entries based on the white point to one-dimensional look-up tables; and,
performing trilinear interpolation based on the mapped data.

8. The method as set forth in claim 7, further comprising conducting post-processing weighting.

9. The method as set forth in claim 4, further comprising adjusting background.

10. The method of claim 7, wherein processing background comprises collecting a histogram of the L*a*b* image data.

11. The method of claim 10, wherein processing background comprises analyzing the histogram of the L*a*b* image data to determine a background color value.

12. The method of claim 11, wherein processing background comprises processing or adjusting pixels based on proximity of a pixel value to the determined background color value.

13. A non-transitory computer readable medium having stored thereon instructions that, when executed, cause a system to:
receive input RGB image data;
convert the input RGB image data to L*a*b* image data;
process background of the L*a*b* image data;
determine a white point of the background;
map entries based on the white point to one-dimensional look-up tables; and,
perform trilinear interpolation based on the mapped data.

14. The non-transitory computer readable medium as set forth in claim 13, wherein the executed instructions further cause the system to conduct post-processing weighting.

15. The non-transitory computer readable medium as set forth in claim 13, wherein the executed instructions further cause the system to adjust background.

16. The non-transitory computer readable medium of claim 13, wherein processing background comprises collecting a histogram of the L*a*b* image data.

17. The non-transitory computer readable medium of claim 16, wherein processing background comprises analyzing the histogram of the L*a*b* image data to determine a background color value.

18. The non-transitory computer readable medium of claim 17, wherein processing background comprises processing or adjusting pixels based on proximity of a pixel value to the determined background color value.

19. An image processing system comprising:
at least one processor; and
at least one memory wherein the memory has instructions stored thereon that, when executed by the processor, cause the system to:
receive input image data having values defined in an input color space;
convert the input image data to device independent image data having values defined in device independent color space;
process background of the device independent image data;
determine a white point of the background;
map entries based on the white point to one-dimensional look-up tables; and,
perform trilinear interpolation based on the mapped data.
